(19) United States
(12) Patent Application Publication
(10) Pub. No.: US 2020/0264946 A1
(43) Pub. Date: Aug. 20, 2020

(54) FAILURE SIGN DETECTION DEVICE, FAILURE SIGN DETECTION METHOD, AND RECORDING MEDIUM IN WHICH FAILURE SIGN DETECTION PROGRAM IS STORED

(71) Applicant: NEC Platforms, Ltd., Kawasaki-shi, Kanagawa (JP)

(72) Inventor: Takashi IIDA, Kanagawa (JP)

(73) Assignee: NEC Platforms, Ltd., Kawasaki-shi, Kanagawa (JP)

(21) Appl. No.: 16/644,546

(22) PCT Filed: Sep. 13, 2018
(86) PCT No.: PCT/JP2018/033926

§ 371 Date: Mar. 5, 2020

(30) Foreign Application Priority Data
Sep. 14, 2017 (JP) 2017-176812

(51) Int. Cl. G06F 11/07

(52) U.S. Cl. CPC G06F 11/0787; G06F 11/0757; G06F 11/0727

(57) ABSTRACT

A failure sign detection device is provided with: an issuing unit that issues an access request for inspection of a storage device at a predetermined first timing, and at a second timing later than the first timing; a collection unit that collects, for each access request for inspection, information representing operating characteristics at a time when the storage device operates, in response to the access request for inspection; a storage unit that stores first operating characteristic information representing operating characteristics at the first timing and second operating characteristic information representing operating characteristics at the second timing; and a generation unit that determines a difference between the first operating characteristic information and the second operating characteristic information, thereby generating degradation information representing a state of degradation of the storage device, and thus detecting a failure sign with high accuracy before the storage device fails.

### TECHNICAL FIELD

The present invention relates to a technique of detecting a failure sign before a storage device fails.

### BACKGROUND ART

In a storage device, after use of the storage device is started, degradation progresses with elapse of time, and a failure is more likely to occur as the degradation progresses. Therefore, in order to enhance availability of a computer system including such a storage device, there is growing expectation for a technique of detecting a failure sign, based on a degree of progress of the degradation of the storage device before a failure occurs in the storage device, thereby avoiding an occurrence of the failure.

As a technique related to such a technique, PTL 1 discloses a magnetic disk device including: a disk drive which is provided with a disk medium and a magnetic head that performs writing or readout of information on the disk medium; and a failure prediction device that performs failure prediction of the disk drive. The failure prediction device performs a seek test for failure sign diagnosis, and stores a result of the seek test and an operating time during execution of the test into a test result storage unit. The failure prediction device sets a failure sign seek time for determining a failure sign, and stores the set failure sign seek time in a failure sign criterion time storage unit. The failure prediction device predicts a time for replacement of a disk medium, based on the test result, the operating time, and the failure sign seek time.

PTL 2 discloses a disk device for acquiring, based on a result of execution of recording processing or readout processing on a disk, a retry rate, an error rate, or a laser diode current value as indication values indicating a level of a problem caused by the disk. This device predicts a failure of the own device by using the retry rate, the error rate, or the laser diode current value, and a threshold of the retry rate, a threshold of the error rate, or a threshold of the laser diose current value which is preset and stored in a flash memory.

In addition, PTL 3 discloses a failure occurrence prediction system for predicting in advance, based on a response from a magnetic disk device for a read/write request, an occurrence of a failure in the magnetic disk device.

This system acquires, based on a system clock, a response time required for response, from a difference between a read/write request issuance time and a data reception time. This system then determines whether the response time exceeds a set normal response time without retry, and records, when determining that the response time exceeds the normal response time, information relating to the magnetic disk device in a database device and determines a degree of progress of damage on the magnetic disk by statistical analysis.

### CITATION LIST

### Patent Literature

[PTL 1] Japanese Unexamined Patent Application Publication No. 2008-84392

[PTL 2] Japanese Unexamined Patent Application Publication No. 2007-294000

[PTL 3] Japanese Unexamined Patent Application Publication No. 2004-118397

### SUMMARY OF INVENTION

### Technical Problem

When a failure sign is detected in a storage device, in general, the degree of degradation of the storage device is determined based on a predetermined criterion (such as a threshold) relating to operating characteristics including an error rate at a time when an access is provided, a latency (response time), or the like. However, the operating characteristics of the storage device are different according to a standard, specifications, performance, or the like thereof, and a variation between individual devices (individual difference) exists as well. Therefore, when determining the degree of degradation of the storage device, based on the predetermined (determined) criterion relating to the operating characteristics, it is difficult to detect a failure sign with high accuracy. The techniques described in PTLs 1 to 3 cannot be said to be sufficient for solving such a program. A primary object of the present invention is to provide a failure sign detection device and the like that solve this problem.

### Solution to Problem

A failure sign detection device according to one aspect of the present invention includes

issuing means for issuing an access request for inspection relative to a storage device at a predetermined first timing, and at a second timing later than the first timing;

collection means for collecting, for each of the access request for inspection, information representing an operating characteristic at a time when the storage device operates, in response to the access request for inspection;

storage means for storing first operating characteristic information representing the operating characteristic at the first timing and second operating characteristic information representing the operating characteristic at the second timing; and

generation means for generating degradation information representing a state of degradation of the storage device by acquiring a difference between the first operating characteristic information and the second operating characteristic information.

In another point of view of achieving the object described above, a failure sign detection method according to one aspect of the present invention includes

by an information processing device:

issuing an access request for inspection for a storage device at a predetermined first timing, and at a second timing later than the first timing;

collecting, for each of the access request for inspection, information representing an operating characteristic at a time when the storage device operates, in response to the access request for inspection;

storing first operating characteristic information representing the operating characteristic at the first timing and second operating characteristic information representing the operating characteristic at the second timing; and

generating degradation information representing a state of degradation of the storage device by acquiring a difference between the first operating characteristic information and the second operating characteristic information.

In addition, in yet another point of view of achieving the object described above, a failure sign detection program according to one aspect of the present invention causes a computer to execute:

issuing processing of issuing an access request for inspection for a storage device at a predetermined first timing, and at a second timing later than the first timing;

collection processing of collecting, for each of the access request for inspection, information representing an operating characteristic at a time when the storage device operates, in response to the access request for inspection;

storage processing of storing first operating characteristic information representing the operating characteristic at the first timing and second operating characteristic information representing the operating characteristic at the second timing; and

generation processing of generating degradation information representing a state of degradation of the storage device by acquiring a difference between the first operating characteristic information and the second operating characteristic information.

Further, the present invention can be achieved by a computer-readable nonvolatile recording medium in which the failure sign detection program (computer program) is stored.

### Advantageous Effects of Invention

The present invention enables detecting a failure sign with high accuracy before a storage device fails.

### BRIEF DESCRIPTION OF DRAWINGS

FIG. 1 is a block diagram schematically illustrating a configuration of a failure sign detection system 1 according to a first embodiment of the present invention.

FIG. 2 is a flowchart illustrating an operation of generating information of operating characteristics of a storage device 20 by a failure sign detection device 10 according to the first example embodiment of the present invention, when use of the storage device 20 is started.

FIG. 3 is a flowchart illustrating an operation of generating degradation information by the failure sign detection device 10 according to the first example embodiment of the present invention.

FIG. 4 is a block diagram schematically illustrating a configuration of a failure sign detection device 40 according to a second example embodiment of the present invention.

FIG. 5 is a block diagram illustrating a configuration of an information processing device 900 that is capable of executing the failure sign detection device according to the example embodiments of the present invention.

### EXAMPLE EMBODIMENT

Hereinafter, example embodiments of the present invention will be described in detail with reference to the drawings.

### First Example Embodiment

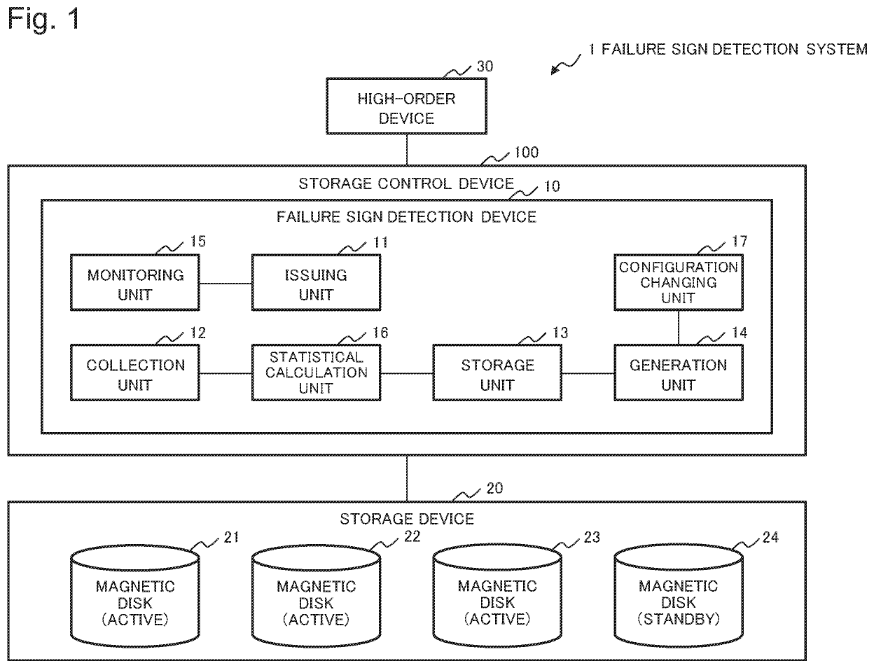

FIG. 1 is a block diagram schematically illustrating a configuration of a failure sign detection system 1 according to a first example embodiment of the present invention. The failure sign detection system 1 roughly has a storage control device (storage controller) 100, a storage device 20, and a high-order device (host device) 30.

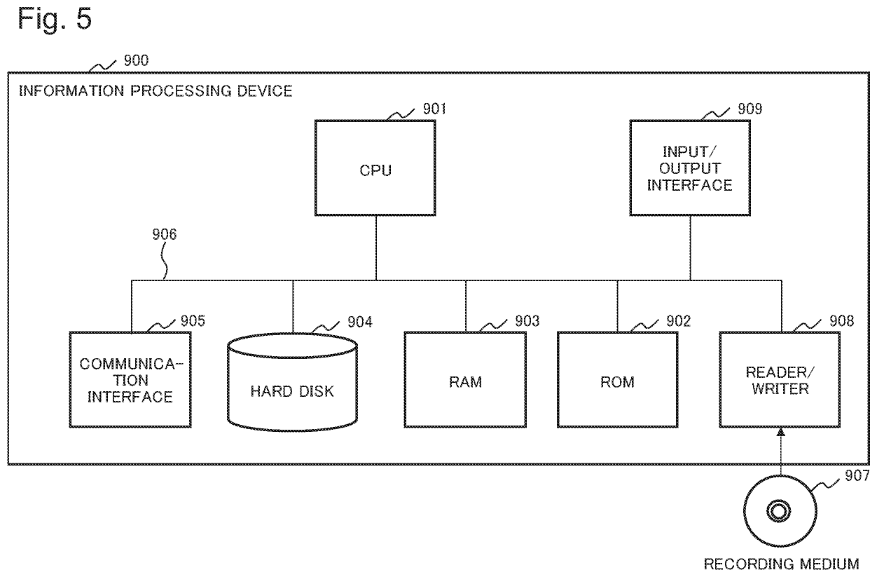

The high-order device 30 is an information processing device which includes a central processing unit (CPU), a memory, and the like (not illustrated), such as a server device having a configuration which will be described later by referring to FIG. 5 for example, and accesses data stored in the storage device 20. The storage control device 100 is a device which controls the storage device 20, and processes a request to the storage device 20, which is received from the high-order device 30. In addition, the storage control device 100 controls failure processing to be performed relative to a failure that occurs in the storage device 20.

The storage device 20 has four magnetic disks 21 to 24 that are memory devices. Note that the number of magnetic disks included in the storage device 20 is not limited to four. A memory device included in the storage device 20 is not limited to a magnetic disk, either. The storage device 20 may be equipped with a memory device such as a solid state drive (SSD), for example.

The storage device 20 may include a redundant configuration in which magnetic disks 21 to 23 are provided as active disks that perform normal operation, and a magnetic disk 24 is provided as a standby disk that can be used by replacing a magnetic disk in which a failure occurs, for example. In addition, the storage device 20 may configure redundant arrays of inexpensive disks (RAID) such as RAID 5 with the magnetic disks 21 to 23, for example, in order to improve availability. Note that the RAID is well-known art and thus in the present application, a detailed description of the RAID is omitted.

The storage control device 100 has a failure sign detection device 10. The failure sign detection device 10 has a function of generating, in order to detect a failure sign relating to the magnetic disks 21 to 24 included in the storage device 20, degradation information representing a state of degradation of the magnetic disks themselves, based on operating characteristics of the magnetic disks 21 to 24.

The failure sign detection device 10 includes an issuing unit 11, a collection unit 12, a storage unit 13, a generation unit 14, a monitoring unit 15, a statistical calculation unit 16, and a configuration changing unit 17. Hereinafter, the present application describes an operation to be performed relative to the magnetic disk 21 by the failure sign detection device 10, and an operation to be performed relative to each of the magnetic disks 22 to 24 by the failure sign detection device 10 is similar to the operation to be performed relative to the magnetic disk 21 as well.

The issuing unit 11 issues an access request for inspection to provide an access to the magnetic disk 21 when use of the magnetic disk 21 is started (first timing), and also at a second timing after the use of the magnetic disk 21 has been started. However, the second timing is a timing indicated by the monitoring unit 15 which will be described later. The access request for inspection is not an access request issued from the high-order device 30, but a dummy access request issued to inspect a state of degradation of the magnetic disk 21.

By this access request for inspection, the failure sign detection device 10 executes at least any of the following accesses to the magnetic disk 21, for example. Note that the following accesses are merely listed as one example, and an access to be executed by the failure sign detection device 10 is not limited to the following accesses. The failure sign detection device 10 executes, when the magnetic disk 21 is equipped with a cache, an access request for inspection in a state in which the cache is disabled, in order to accurately acquire the operating characteristics of the magnetic disk 21.
(1) An access to seek an outermost track and an innermost track of the magnetic disk 21
(2) A plurality of accesses having data transfer lengths different each other
(3) An access involving switching of a magnetic head
(4) A sequential (read and write) access
(5) A random (read and write) access
   However, the sequential access is an operation of accessing, in sequential order of address, a contiguous storage area in the magnetic disk 21. In addition, the random access is an operation of accessing, without depending on the sequential order of address, a plurality of storage areas of which addresses are different from one another in the magnetic disk 21.

The issuing unit 11 may respectively issue the access request of an identical type a plurality of times in order for the statistical calculation unit 16, which will be described later, to be able to perform statistical calculation relative to the operating characteristics relating to the magnetic disk 21.

The monitoring unit 15 monitors a state of loading relating to an access from the high-order device 30 to the storage device 20. The monitoring unit 15 determines whether a second timing at which the state of loading satisfies a predetermined condition has been reached. The monitoring unit 15 may use, as the predetermined condition, the fact that an access from the high-order device 30 to the storage device 20 does not occur or the fact that a load relating to the access is equal to or less than a threshold. The monitoring unit 15 notifies, when determining that the second timing has been reached, a result of the determination to the issuing unit 11. In addition, the monitoring unit 15 may notify the result of the determination to the issuing unit 11 each time the second timing is determined.

The issuing unit 11 issues the access request for inspection, as described above, when the fact that the second timing has been reached is notified from the monitoring unit 15. The issuing unit 11 sets, at this juncture, as a storage area to be accessed by the access request for inspection, a storage area (unused storage area) that is not used by the high-order device 30 in the magnetic disk 21. This is because the data stored in the magnetic disk 21, which is used by the high-order device 30, is not damaged by a write access due to the access request for inspection.

The collection unit 12 collects, for each access request for inspection, information representing the operating characteristics at a time when the storage device 20 operates, in response to the access request for inspection issued by the issuing unit 11. The collection unit 12 collects, as information representing the operating characteristics, at least any of a seek time, a rotation waiting time, and a data transfer time, for example. However, the seek time is a time required for the magnetic head of the magnetic disk 21 to move to a position of a track in which data targeted for access is stored. The rotation waiting time is a time required for the data targeted for access to come under a magnetic head. The data transfer time is a time required to read out or write data targeted for access. Note that the information representing the operating characteristics collected by the collection unit 12 is not limited to each of the times described above.

The collection unit 12 associates the collected information representing the operating characteristics with the access request for inspection, and stores the associated collected information in the storage unit 13, for example.

The statistical calculation unit 16 performs, with respect to a plurality of times of the access request for inspection of the identical type, which are issued by the issuing unit 11, statistical calculation relative to the information representing the operating characteristics, which is collected by the collection unit 12. However, the statistical calculation is calculation of seeking statistical information such as an average value and a criterion deviation, for example.

The statistical calculation unit 16 stores in the storage unit 13, as first operating characteristic information, the information representing the operating characteristics including statistical information, which is generated by performing the statistical calculation described above, when the use of the magnetic disk 21 is started (first timing). The statistical calculation unit 16 stores in the storage unit 13, as second operating characteristic information, the information representing the operating characteristics including statistical information, which is generated by performing statistical calculation similarly at the second timing described above. However, the storage unit 13 is a storage device such as an electronic memory or a magnetic disk.

The generation unit 14 generates, by finding a difference between the first operating characteristic information and the second operating characteristic information that are stored in the storage unit 13 by the statistical calculation unit 16, degradation information representing the state of degradation of the magnetic disk 21 (a degree of degradation of the magnetic disk 21 from a time when the use of the magnetic disk 21 is started to the second timing described above). In addition, the generation unit 14 may determine whether a value representing the state of degradation of the magnetic disk 21 is equal to or more than a threshold, and include, when the value representing the state of degradation is equal to or more than the threshold, recommendation of preventive replacement of the magnetic disk 21. The generation unit 14 transmits the generated degradation information to the high-order device 30 used by a system administrator, for example.

The configuration changing unit 17 has a function of changing a configuration of the storage device 20 when the storage device 20 includes a plurality of active (primary) disks configuring the RAID and a standby (secondary) disk. For example, it is considered that there is a case where the storage device 20 configures the RAID 5 with the magnetic disks 21 to 23 that are active disks, and includes the magnetic disk 24 as a standby disk. In addition, it is assumed that the degradation information generated by the generation unit 14 indicates recommendation of preventive replacement of the magnetic disk 21. In this case, the configuration changing unit 17 first copies the data stored in the magnetic disk 21 to the magnetic disk 24. The configuration changing unit 17 changes a configuration of the RAID 5 in such a way as to incorporate the magnetic disk 24 in place of the magnetic disk 21. The configuration changing unit 17 notifies the high-order device 30, for example, that the configuration of the RAID 5 in the storage device 20 has changed.

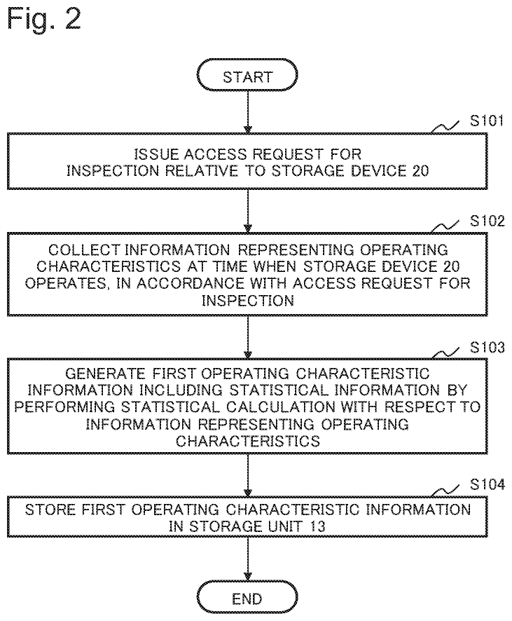

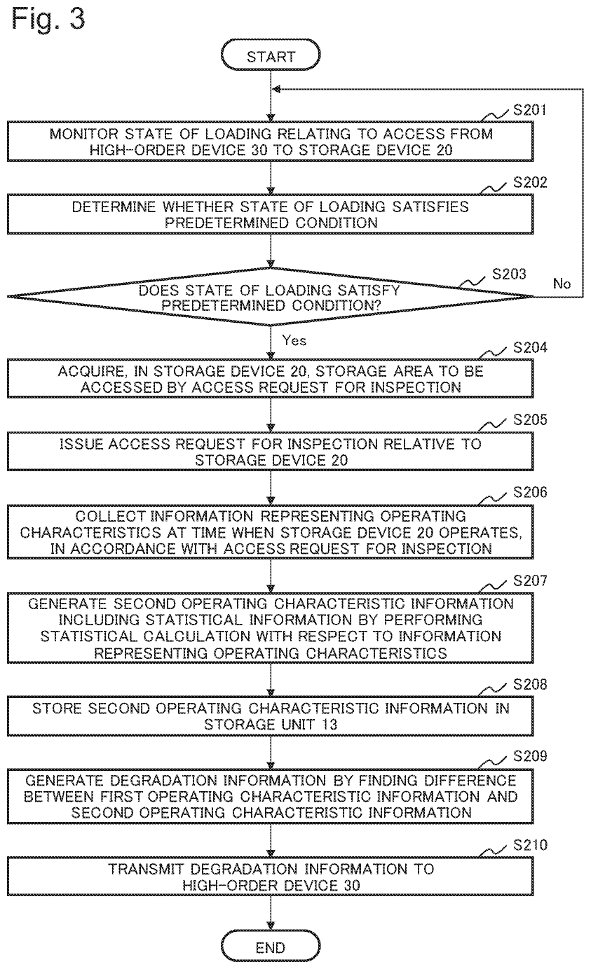

Next, referring to the flowcharts of FIG. 2 and FIG. 3, an operation (processing) of the failure sign detection device 10 according to the present example embodiment will be described in detail.

FIG. 2 is a flowchart illustrating an operation of generating, by the failure sign detection device 10 according to the present example embodiment, operating characteristic information of the storage device 20 when use of the storage device 20 is started (first timing).

The issuing unit 11 issues an access request for inspection to the storage device 20 (step S101). The collection unit 12 collects information representing operating characteristics at a time when the storage device 20 operates, in response to the access request for inspection (step S102).

The statistical calculation unit 16 generates first operating characteristic information including statistical information by performing statistical calculation with respect to the information representing the operating characteristics collected by the collection unit 12 (step S103). The statistical calculation unit 16 stores the generated first operating characteristic information in the storage unit 13 (step S104), and the entire processing completes.

FIG. 3 is a flowchart illustrating an operation of generating degradation information relating to the storage device 20 by the failure sign detection device 10 according to the present example embodiment.

The monitoring unit 15 monitors a state of loading relating to an access from the high-order device 30 to the storage device 20 (step S201). The monitoring unit 15 determines whether the state of loading satisfies a predetermined condition (step S202). When the state of loading does not satisfy the predetermined condition (No in step S203), processing reverts to step S201. When the state of loading satisfies the predetermined condition (Yes in step S203), the issuing unit 11 acquires, in the storage device 20, a storage area to be accessed by the access request for inspection (step S204).

The issuing unit 11 issues the access request for inspection to the storage device 20 (step S205). The collection unit 12 collects information representing operating characteristics at a time when the storage device 20 operates, in response to the access request for inspection (step S206).

The statistical calculation unit 16 generates second operating characteristic information including statistical information by performing statistical calculation with respect to information representing operating characteristics (step S207). The statistical calculation unit 16 stores the generated second operating characteristic information in the storage unit 13 (step S208).

The generation unit 14 generates degradation information by finding a difference between the first operating characteristic information and the second operating characteristic information that are stored in the storage unit 13 (step S209). The generation unit 14 transmits the generated degradation information to the high-order device 30 (step S210), and the entire processing completes.

The failure sign detection device 10 according to the present example embodiment can detect a failure sign with high accuracy before a storage device fails. This is because the failure sign detection device 10 issues the access request for inspection to the storage device 20 at a predetermined first timing, and also at a second timing subsequent to the first timing to thereby collect operating characteristic information of the storage device 20 at these timings and then generate, based on the collected operating characteristic information, the degradation information relating to the storage device 20.

Hereinafter, advantageous effects achieved by the failure sign detection device 10 according to the present example embodiment will be described in detail.

When a failure sign is detected in a storage device, in general, a degree of degradation of the storage device is determined based on a predetermined criterion (such as threshold) relating to operating characteristics including an error rate at a time when an access is provided, a latency, or the like. However, the operating characteristics of the storage device are different depending on the standard, the specifications, the performance, or the like, and a variation in individuals (individual difference) exists as well. Therefore, when determining the degree of degradation of the storage device, based on the predetermined criterion relating to the operating characteristics, it is difficult to detect a failure sign with high accuracy.

To deal with such a problem, the failure sign detection device 10 according to the present example embodiment includes the issuing unit 11, the collection unit 12, the storage unit 13, and the generation unit 14, and operates as described above referring to FIG. 1 to FIG. 3, for example. That is, the issuing unit 11 issues the access request for inspection to the storage device 20 at a predetermined first timing, and also at a second timing later than the first timing. The collection unit 12 collects, for each access request for inspection, information representing operating characteristics at a time when the storage device 20 operates, in response to the access request for inspection. The storage unit 13 stores first operating characteristic information representing the operating characteristics at the first timing and second operating characteristic information representing the operating characteristics at the second timing. Afterwards, the generation unit 14 generates degradation information representing the state of degradation of the storage device 20 by finding the difference between the first operating characteristic information and the second operating characteristic information.

That is, the information to be used when the failure sign detection device 10 generates the degradation information is a difference (relative value) in the information representing the operating characteristics collected at a predetermined first timing, and also at the second timing subsequent to the first timing, and is not an absolute value represented by the information representing the operating characteristics at a certain timing. The failure sign detection device 10 can generate, by using such a relative value unlike the case of using the absolute value, degradation information considering (neutralizing) the standard, the specifications, the performance, or a characteristic variation which is different depending on the storage device. Thus, this detection device can detect a failure sign with high accuracy before the storage device 20 fails.

The first timing described above is also a predetermined (predetermined) timing such as a time when use of the storage device 20 is started, for example. That is, the first timing is fixed (a condition (environment) for generating degradation information is equalized), and the failure sign detection device 10 can thereby detect a failure sign before the storage device 20 fails. Note that the first timing is not limited to a time when the use of the storage device 20 is started. The first timing may be a timing and the like used over a predetermined time after the use of the storage device 20 has been started, for example.

In addition, the monitoring unit 15 according to the present example embodiment monitors a state of loading relating to an access from the high-order device 30 to the storage device 20, and determines whether a second timing at which the state of loading satisfies a predetermined condition (such as the fact that a load on the access is equal to or less than a threshold) has been reached. That is, the failure sign detection device 10 according to the present example embodiment can detect a failure sign with high accuracy before the storage device 20 fails, by equalizing the condition (environment) for generating degradation information at the second timing as well.

In addition, the statistical calculation unit 16 according to the present example embodiment generates the above-described first and second operating characteristic information including statistical information by performing statistical calculation (such as calculation of average value) with respect to the information representing the operating characteristics relating to a plurality of times of the access request of the identical type, which is issued by the issuing unit 11. In such a manner, the failure sign detection device 10 according to the present example embodiment can detect a failure sign with higher accuracy before the storage device 20 fails.

In addition, the issuing unit 11 according to the present example embodiment acquires in advance an unused storage area in the storage device 20 as a storage area to be accessed by the issued access request. In such a manner, the failure sign detection device 10 according to the present example embodiment prevents the data stored in the magnetic disk 21, which are used by the high-order device 30, from being damaged by a write access due to the access request for inspection. Thus, this detection device can safely perform detection of a failure sign.

Further, the failure sign detection device 10 according to the present example embodiment includes a configuration changing unit 17 that is capable of changing the configuration of the storage device 20 including the magnetic disks 21 to 23 that are active disks configuring the RAID and the magnetic disk 24 that is a standby disk. The configuration changing unit 17 copies, when the value indicating the state of degradation relating to the magnetic disk 21 is equal to or more than the threshold for example, the data stored in the magnetic disk 21 to the magnetic disk 24 and thereafter changes the configuration of the RAID in such a way as to incorporate the magnetic disk 24 in place of the magnetic disk 21. Therefore, the failure sign detection device 10 according to the present example embodiment can enhance availability of the storage device 20, based on a result of detection of a failure sign.

Furthermore, the failure sign detection device 10 according to the present example embodiment may include a simple configuration which does not include at least any of the monitoring unit 15, the statistical calculation unit 16, and the configuration changing unit 17.

### Second Example Embodiment

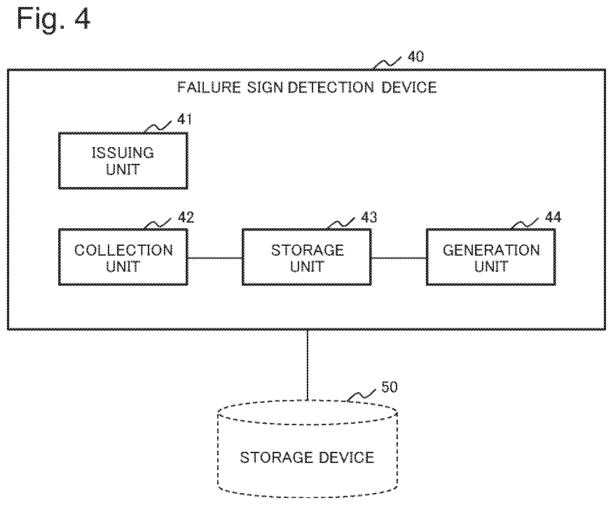

FIG. 4 is a block diagram schematically illustrating a configuration of a failure sign detection device 40 according to a second embodiment of the present invention.

The failure sign detection device 40 according to the present example embodiment includes an issuing unit 41, a collection unit 42, a storage unit 43, and a generation unit 44.

The issuing unit 41 issues an access request for inspection to a storage device 50 at a predetermined first timing, and also at a second timing later than the first timing.

The collection unit 42 collects, for each access request for inspection, information representing operating characteristics at a time when the storage device 50 operates, in response to the access request for inspection.

The storage unit 43 stores first operating characteristic information representing the operating characteristics at the first timing and second operating characteristic information representing the operating characteristics at the second timing.

The generation unit 44 generates degradation information representing a state of degradation of the storage device 50 by finding a difference between the first operating characteristic information and the second operating characteristic information.

The failure sign detection device 40 according to the present example embodiment can detect a failure sign with high accuracy before a storage device fails. This is because the failure sign detection device 40 issues the access request for inspection to the storage device 50 at a predetermined first timing, and also at a second timing subsequent to the first timing to thereby collect operating characteristic information of the storage device 50 at these timings and then generate, based on the collected operating characteristic information, the degradation information relating to the storage device 50.

### <Example of Hardware Configuration>

In the example embodiments described above, the constituent elements in the failure sign detection device illustrated in FIG. 1 and FIG. 4 can be implemented by dedicated hardware (HW) (electronic circuit). In addition, in FIG. 1 and FIG. 4, at least the constituent elements listed below can be taken as software program function (processing) units (software modules).
Issuing units 11 and 41
Collection units 12 and 42
Storage control function in storage units 13 and 43
Generation units 14 and 44
Monitoring unit 15
Statistical calculation unit 16
Configuration changing unit 17

However, division of the constituent elements illustrated in these figures is merely a configuration for convenience of explanation, and various configurations can be presupposed at the time of implementation. One example of a hardware environment in this case will be described referring to FIG. 5.

FIG. 5 is a diagram exemplarily illustrating a configuration of an information processing device 900 (computer) that is capable of executing the failure sign detection devices according to the example embodiments of the present invention. That is, FIG. 5 represents the configuration of the computer (information processing device) that is capable of implementing the failure sign detection device illustrated in FIG. 1 and FIG. 4 and a hardware environment that is capable of implementing the functions in the example embodiments described above.

The information processing device 900 illustrated in FIG. 5 includes the constituent elements listed below.
Central processing unit (CPU) 901
Read only memory (ROM) 902
Random access memory (RAM) 903
Hard disk (storage device) 904
Communication interface 905 with external device
Bus 906 (communication line)
Reader/writer 908 that is capable of reading/writing data stored in a recording medium 907 such as compact disc read only memory (CD-ROM)
Input/output interface 909

That is, the information processing device 900 including the constituent elements listed above is a general computer in which these constituent elements are connected via the bus 906. The information processing device 900 may be equipped with a plurality of CPUs 901 or may be equipped with the CPU 901 composed of multicores.

The present invention described by presenting the above example embodiments as examples then supplies a computer program that is capable of implementing the following functions to the information processing device 900 illustrated in FIG. 5. The functions are the above constituent elements in the block diagrams (FIG. 1 and FIG. 4) referred to in the description of the example embodiments or functions in the flowcharts (FIG. 2 and FIG. 3). The present invention is thereafter achieved by reading out, interpreting, and executing the computer program in the CPU 901 as the hardware. In addition, the computer program supplied into the device may be stored in a readable/writable volatile memory (RAM 903) or a nonvolatile storage device such as the ROM 902 and the hard disk 904.

In addition, in the case above, as a method for supplying the computer program into the hardware, a currently general procedure can be employed. As the procedure, for example, there is a method for installing the computer program in the device via various recording media 907 such as a CD-ROM or a method for externally downloading the computer program via a communication line such as the Internet. Further, in such a case, the present invention can be construed to be composed of a code configuring the computer program or the recording medium 907 in which the code is stored.

Hereinabove, the present invention has been described by taking the above example embodiments as typical examples. However, the present invention is not limited to the above example embodiments. That is, according to the present invention, various aspects which may be understood by a person skilled in the art can be applied within the scope of the present invention.

This application is based upon and claims the benefit of priority from Japanese Patent Application No. 2017-176812, filed on Sep. 14, 2017, the disclosure of which is incorporated herein in its entirety by reference.

### REFERENCE SIGNS LIST

1 Failure sign detection system
10 Failure sign detection device
11 Issuing unit
12 Collection unit
13 Storage unit
14 Generation unit
15 Monitoring unit
16 Statistical calculation unit
17 Configuration changing unit
100 Storage control device
20 Storage device
21 to 24 Magnetic disk
30 High-order device
40 Failure sign detection device
41 Issuing unit
42 Collection unit
43 Storage unit
44 Generation unit
50 Storage device
900 Information processing device
901 CPU
902 ROM
903 RAM
904 Hard disk (storage device)
905 Communication interface
906 Bus
907 Recording medium
908 Reader/Writer
909 Input/output interface

What is claimed is:

1. A failure sign detection device comprising:
at least one memory storing a computer program; and
at least one processor configured to execute the computer program to:
issue an access request for inspection relative to a storage device at a predetermined first timing, and at a second timing later than the first timing;
collect, for each of the access request for inspection, information representing an operating characteristic at a time when the storage device operates, in response to the access request for inspection;
store in the memory first operating characteristic information representing the operating characteristic at the first timing and second operating characteristic information representing the operating characteristic at the second timing; and
generate degradation information representing a state of degradation of the storage device by acquiring a difference between the first operating characteristic information and the second operating characteristic information.

2. The failure sign detection device according to claim 1, wherein the processor is configured to execute the computer program to:
monitor a state of loading relating to an access from a high-order device to the storage device, and determine whether the second timing at which the state of loading satisfies a predetermined condition is reached.

3. The failure sign detection device according to claim 1 wherein the processor is configured to execute the computer program to:
issue the access request for inspection of an identical type a plurality of times, and
generate the first and second operating characteristic information including statistical information by performing statistical calculation with respect to information representing the operating characteristic relating to a plurality of times of the access request for inspection of the identical type.

4. The failure sign detection device according to claim 1 wherein the processor is configured to execute the computer program to:
issue the access request for inspection, relative to the storage device having a magnetic disk, for executing at least any of an access of seeking an outermost track and an innermost track of the magnetic disk, a plurality of accesses having data transfer lengths different each other, an access with switching of a magnetic head, a sequential access, and a random access.

5. The failure sign detection device according to claim 4, wherein the processor is configured to execute the computer program to:
collect the information representing the operating characteristic including at least any of a seek time, a rotation waiting time, and a data transfer time.

6. The failure sign detection device according to claim 1 wherein the processor is configured to execute the computer program to:
issue the access request for inspection relative to the storage device at the first timing when use of the storage device is started.

7. The failure sign detection device according to claim 1 wherein the processor is configured to execute the computer program to:
set an unused storage area in the storage device as a storage area to be accessed by the access request for inspection to be issued.

8. The failure sign detection device according to claim 1, wherein the processor is configured to execute the computer program to:
change a configuration of the storage device including a plurality of active disks configuring redundant arrays of inexpensive disks (RAID) and a standby disk, wherein
generate the degradation information indicating whether a value representing the state of degradation of the plurality of active disks and the standby disk is equal to or more than a threshold, and
when the degradation information indicates that the state of degradation relating to a specific active disk among the plurality of active disks is equal to or more than a threshold, copy data stored in the specific active disk to the standby disk, and then change a configuration of the RAID in such a way as to incorporate the standby disk in place of the specific active disk.

9. A failure sign detection method comprising, by an information processing device:
issuing an access request for inspection for a storage device at a predetermined first timing, and at a second timing later than the first timing;
collecting, for each of the access request for inspection, information representing an operating characteristic at a time when the storage device operates, in response to the access request for inspection;
storing in a memory first operating characteristic information representing the operating characteristic at the first timing and second operating characteristic information representing the operating characteristic at the second timing; and
generating degradation information representing a state of degradation of the storage device by acquiring a difference between the first operating characteristic information and the second operating characteristic information.

10. A non-transitory computer-readable recording medium in which a failure sign detection program is stored, the program for causing a computer to execute:
issuing an access request for inspection for a storage device at a predetermined first timing, and at a second timing later than the first timing;
collecting, for each of the access request for inspection, information representing an operating characteristic at a time when the storage device operates, in response to the access request for inspection;
storing in a memory first operating characteristic information representing the operating characteristic at the first timing and second operating characteristic information representing the operating characteristic at the second timing; and
generating degradation information representing a state of degradation of the storage device by acquiring a difference between the first operating characteristic information and the second operating characteristic information.
